(19) United States
(12) Patent Application Publication
(10) Pub. No.: US 2004/0085210 A1
(43) Pub. Date: May 6, 2004

(54) Personal monitoring system

(75) Inventor: Marcus Ziesing, Munich (DE)

Correspondence Address: SIERRA PATENT GROUP, LTD., P O BOX 6149, STATELINE, NV, 89449, US

(73) Assignee: Matronixx, Vertriebsgesellschaft mbH, a German corporation

(21) Appl. No.: 10/640,869

(22) Filed: Aug. 13, 2003

(30) Foreign Application Priority Data
Aug. 13, 2002 (DE) 202 12 475.4

(51) Int. Cl. G08B 23/00

(52) U.S. Cl. 340/573.4; 340/539.11

(57) ABSTRACT

A system for the monitoring of persons, in particular of children and of adults requiring supervision, comprise a portable transmitter, a receiver and a warning device provided at the receiver as well as means by which the warning device is caused to output a warning signal when the distance between the transmitter and the receiver exceeds a predetermined value, in particular an adjustable value, whereby additional means are provided at the transmitter for the voluntary transmission of a signal which causes the receiver to output a warning signal.

### PRIORITY CLAIMS

This application claims first priority of German Patent No. 202 12 475.4 filed Aug. 13, 2002 in the German language.

### BACKGROUND

The present invention relates to a system for the monitoring of persons, in particular of children and of adults requiring supervision, comprising a portable transmitter, a receiver and a warning device provided at the receiver as well as means by which the warning device is caused to output a warning signal when the distance between the transmitter and the receiver exceeds a predetermined value, in particular an adjustable value. person to do so. The risk exists that the children run away and become lost or get into danger.

Known systems of the type allow a monitoring of children and of adults requiring supervision without the requirement of keeping the children permanently in sight or even taking them by the hand. The freedom of movement of the children is less restricted thereby and good monitoring is nevertheless provided.

### SUMMARY

It is the underlying object of the invention to further improve the system initially named. In particular an even better reaction possibility to dangers which occur should be provided.

This object is satisfied in that additional means are provided at the transmitter for the voluntary transmission of a signal which causes the receiver to output a warning signal.

The child or the adult requiring supervision has the possibility by the additionally provided means to warn the supervising person directly in the even of a danger occurring which they have recognized. It is therefore also possible to inform the supervising person without exceeding the permitted distance between the child or the adult requiring supervision and the supervising person and the latter can then react immediately. If, for example, the child is out of sight of or out of calling distance to the supervising person, it can alarm the supervising person when it becomes afraid or if somebody wants to do something to it. The supervising person can then immediately start looking for the child, in particular using the aid of a search mode into which the system can be switched. The search mode can, for example, be designed such that the warning signal becomes more intense, in particular louder or faster. The supervising person can thereby faster detect the direction he must go in order to reach the child or the adult person requiring supervision.

A button, in particular a micro-button, is provided as the actuation means for the voluntary transmission of a signal. It can be easily actuated by the child or by the adult requiring supervision so that the transmission of the signal can take place fast.

In accordance with a further embodiment of the invention, a warning signal is also output by the transmitter on the actuation of the transmission means. It is in particular designed as a deterrent signal. A person who wants to do something to the child or to the adult requiring supervision, for example to kidnap said child or adult, can thus be deterred and adults in the vicinity can be made aware of the situation.

In particular optical and/or acoustic signals can be provided as the warning signal. In particular an acoustic signal is advantageous as a deterrent signal.

A further improvement of the initially named system results in that the transmitter has means for releasable fastening to a person, said means being fitted with a securing device which results in the triggering of an alarm at the transmitter and/or at the receiver on unauthorized release of the fastening. It can thus be prevented that a person attacking the child removes the transmitter without being noticed. Persons in the vicinity are also made aware of the situation by the outputting of an alarm signal, in particular of a deterrent signal, at the transmitter. This embodiment is also effective against an unnoticed removal of the transmitter by the child itself.

A clip can preferably be provided as the fastening means having two electrical contacts which are closed when the clip is fastened and form part of an alarm circuit. If the transmitter is removed from the child or from the person requiring supervision, the electrical contacts are also automatically removed. This can be used for the triggering of an alarm at the transmitter and/or at the receiver.

### BRIEF DESCRIPTION OF THE DRAWINGS

An embodiment of the invention is shown in the drawing and will be described in the following. The only Figure shows in a schematic representation:

FIG. 1 a transmitter and a receiver of the system in accordance with the invention.

### DETAILED DESCRIPTION

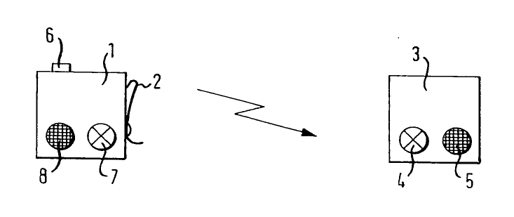

The transmitter 1 is made as small as possible and is provided with a fastening device, for example a clip 2 or a band, in order to be able to be fastened to a person, for example to the jacket or the wrist of a child. The receiver also shown in FIG. 1 is also portable and preferably likewise has a small size.

The transmitter 1 and the receiver 3 in particular cooperate in accordance with the radio principle in that the transmitter 1 transmits a radio signal which is received by the receiver 3. The receiver 3 can determine the distance from the transmitter 1 via the strength of reception and can trigger a warning signal on the exceeding of a predetermined distance. The receiver 3 has a lighting means, in particular at least one light emitting diode 4, to output the warning signal as well as a loudspeaker 5 to output an acoustic warning signal.

The transmitter 1 is fitted with a button 6 via which a radio signal can be voluntarily transmitted to the receiver 3 in order to cause this to output a warning signal. In addition, the transmitter 1 also has a lighting means, in particular at least one light emitting diode 7, and a loudspeaker 8 for the output of an optical and of an acoustic warning signal. The acoustic warning signal is above all in particular designed as a deterrent signal. A very loud and high or siren-like tone can, for example, be output when the button 6 is actuated.

In its section opposite the housing of the transmitter 1, the clip 2 of the transmitter 1 has an electrical contact which is not shown here and which cooperates with an electrical contact at the housing of the transmitter 1. A circuit is closed by the two electrical contacts contacting and its interruption results in a triggering of an alarm. When the transmitter 1 is removed from the child or from the person requiring supervision, a warning signal, in particular a deterrent signal, is output. Other fastening means can also be used instead of a clip 2, for example cable loops which serve as the carriers for the alarm circuit. An alarm is again appropriately triggered on the cutting of the cable loops led, for example, through a piece of clothing.

The system described has the advantage that a warning signal can be produced voluntarily at the receiver. In addition, a deterrent signal can be produced at the transmitter to frighten off an attacker. The fastening apparatus with an alarm circuit moreover allows a triggering of an alarm on the unauthorized removal of the transmitter from the child or from the person requiring supervision. Particularly high security is thus achieved by the system in accordance with the invention.

1. A system for the monitoring of persons, in particular of children and of adults requiring supervision, comprising:
a portable transmitter
a receiver in operative communication with said portable transmitter;
a warning device coupled to said receiver;
a warning signal means configured to output a warning signal responsive to an adjustable predetermined distance between the portable transmitter and the receiver; and
a voluntary transmission means coupled to said portable transmitter said voluntary transmission means configured for the voluntary transmission of a signal which causes the receiver to output a warning signal.

2. The system in accordance with claim 1 wherein the voluntary transmission means includes a button.

3. The system in accordance with claim 2 wherein said button is a micro-button.

4. The system in accordance with claim 1 wherein a warning signal is also output by the portable transmitter responsive to the actuation of said voluntary transmission means.

5. The system in accordance with claim 1 wherein said warning signal comprises at least one of an optical warning signal and an acoustic warning signal.

6. The system in accordance with claim 5 wherein said warning signal output by the portable transmitter is made as a deterrent signal.

7. The system in accordance with claim 1 wherein the receiver is configured to be switched into a mode in which the warning signal becomes more intense as the distance decreases.

8. The system in accordance with claim 7 wherein said mode intensity comprises one of a louder intensity and a faster intensity.

9. A system for the monitoring of persons in particular of children and of adults requiring supervision, comprising:
a portable transmitter;
a receiver in operative communication with said portable transmitter;
a warning device coupled to the receiver;
a warning signal means configured to output a warning signal responsive to an adjustable predetermined distance between said portable transmitter and said receiver; and
a releasable fastening means coupled to said transmitter, said releasable fastening means configured to releasably fasten to a person, said releasable fastening means being fitted with a security device which results in the triggering of an alarm with at least one of said portable transmitter and said receiver responsive to an unauthorized release of said releasable fastening means.

10. The system in accordance with claim 9 wherein said releasable fastening means includes a clip having two electrical contacts which are closed when the clip is fastened and form part of an alarm circuit.
